(19) United States
(12) Patent Application Publication
(10) Pub. No.: US 2012/0201925 A1
(43) Pub. Date: Aug. 9, 2012

(54) ARTIFICIAL RICE AND A METHOD OF MANUFACTURING THE SAME USING INDUSTRIAL PROCESS

(76) Inventor: Daryamehr Keshani, Teharn (IR)

(21) Appl. No.: 13/020,816

(22) Filed: Feb. 4, 2011

(51) Int. Cl. A23L 1/10; A23K 1/175; B65B 55/00; A23L 1/302

(52) U.S. Cl. 426/18; 426/72; 426/74; 426/618; 426/392

(57) ABSTRACT

The various embodiments herein provide a method to produce rice artificially and industrially. The method comprises collecting stock materials, powdering the stock materials, sifting the powdered materials and making paste from the sifted material. The paste is molded and pressed after rubbing to obtaining the rice. The method produces several tonnes of rice per day. The rice is produced in 30 minutes. The rice is produced with different materials in various quantities and qualities based on need of a consumer. The rice is produced with different taste, smell and colour. The rice has properties similar to the natural rice.

### BACKGROUND

1. Technical Field

The embodiments herein generally relate to the field of production of rice and particularly to a method of rice production industrially. The embodiments herein more particularly relate to the production of rice artificially and industrially.

2. Description of the Related Art

Rice is a kind of plant that is planted very much, after wheat, in several countries of the world, because of high requirement and need of people all over the world. Rice has many kinds and sorts. There are around ten thousands brands. Oryza is the most important sort of it and Sativa is its agricultural kind. Rice has stem, leaf, fruit and grain. Rice-grain has its sheath. The sheath is brown or amber in color. The grain forms rice fruit called Shaltook. The natural rice contains elements like potassium, starch, water, phosphorous, iron, sodium, vitamins B1 and B2, protein oil, calcium, etc. But the natural rice has some limitations. The production process of natural rice is very long and expensive. Due to the growing needs and demands of people worldwide, the production of natural rice is becoming difficult to overcome the demands. Moreover, considering the crisis of energy, food and especially water in the world, the use of rice must be economized as far as possible. Also, the natural rice has fixed taste, smell and nutrients. There have been methods that produce rice artificially, but they use rice grains and its wastes to get the final crop.

Hence there is a need for a cheaper, faster and efficient method of production of rice that is similar to the natural rice in all aspects with a variable quality.

The above mentioned shortcomings, disadvantages and problems are addressed herein and which will be understood by reading and studying the following specification.

### OBJECTIVES OF THE INVENTION

The primary object of the embodiments herein is to provide a new method of producing rice industrially and artificially.

Another object of the embodiments herein is to provide a method of production of rice that is fast, efficient and economical.

Yet another object of the embodiments herein is to provide a method of production of rice without any requirement for planting rice in the fields.

Yet another object of the embodiments herein is to provide a method of production of rice with variation of vitamins and minerals and a variation of taste according to the consumers needs.

Yet another object of the embodiments herein is to provide a method of production of rice without any requirement of plantation workers and a method to produce rice in any environmental conditions.

Yet another object of the embodiments herein is to provide a method of production of rice from the grains of all cereals with the same taste and quality as natural rice.

Yet another object of the embodiments herein is to provide a shortened method of production of rice in a day and a method for producing rice in several tones in a day.

Yet another object of the embodiments herein is to provide a method of production of rice that is applicable at any place and at any time.

Yet another object of the embodiments herein is to provide a method of production of rice using different kinds of starches.

Yet another object of the embodiments herein is to provide a dry method of producing rice without any requirement of washing the equipments on daily basis.

Yet another object of the embodiments herein is to produce rice with a taste and smell similar to that of the natural rice.

Yet another object of the embodiments herein is to produce rice with anti-neuritic properties and all properties of natural rice, for compensating anemia, shortage of calcium, protein, etc., and for controlling of blood pressure.

These and other objects and advantages of the embodiments herein will become readily apparent from the following detailed description taken in conjunction with the accompanying drawings.

### SUMMARY

The various embodiments herein provide a method to produce a rice with properties similar to the natural rice artificially and industrially. The rice produced is known as an industrial rice. Industrial rice is the rice that does not require plantation and is produced industrially. The taste and flavors of the industrial rice is varied according to the demands of consumers. The rice is produced very rapidly at a low price. Tones of industrial rice are produced daily using the method disclosed in the embodiments herein. Rice with anti-neuritic properties is also produced. The rice thus produced is used to compensate anemia, shortage of calcium, protein, etc. The rice is also used to control blood pressure.

According to an embodiment herein, the method of producing rice industrially comprises collecting a plurality of stock materials, wherein the plurality of stock materials is selected from a group consisting of starch, grains, vitamins, iron, organic and inorganic materials, paper and wood particles and combination thereof and wherein the starch includes the starch of wheat, corn, barely, potato and wherein the grains include the grains of wheat, barley, chickpea and potato. The stock material is converted into a homogeneous powder. The homogeneous powder of stock materials is sifted and made into a paste by adding water wherein the paste is made using a paste maker lacuna. The water is added up to 20-30% by keeping the temperature at 32-38° C. The paste is mixed using a mixer for 5 minutes at 40° C. Then the paste is rubbed using a pair of roller and then the paste is pressed. The paste is pressed using a machine called cromola machine. The cromola machine has at least a pair of roller and a vacuum. The paste is pressed under vacuum. After pressing, the paste is molded to obtain the rice. The rice is then dried and packed for storage and consumption. The stock material is variable in an amount depending on a consumer's requirement. The rice has particles in a form of nano particles wherein the nano-particles are adhered to each other by a chemical bond. The rice produced according to the embodiments herein is in a quantity of at least 20 tonnes per day. The rice is produced in a period of time of 30 minutes. The mixer used herein is a two wall mixer and a spiral mixer.

According to an embodiment herein, the rice is produced depending on a consumer's requirement. The consumer's requirement includes taste of the rice, colour of the rice, size of the rice and nutrients present in the rice.

According to an embodiment herein, the rice with a plurality of grain size is produced. The plurality of grain size includes long, medium, short and smaller grain size. The long grain size includes a grain size of more than 7 mm. The medium grain size includes a grain size of 6 mm to 7 mm. The short grain size includes a grain size of 5 mm to 6 mm, and the smaller grain size includes a grain size of less than 5 mm.

According to another embodiment herein, the rice with a plurality of weights is produced. The plurality of weights includes very heavy rice grains, heavy rice grains and little heavy rice grains. The very heavy rice grains include a weight of 1000 grains more than 28 gm. The heavy rice grains include a weight of 1000 grains between 22 to 28 gm and the little heavy rice grains include a weight of 1000 grains less than 22 gm.

According to another embodiment herein, the rice can be produced with a mucilage and without a mucilage. The rice with a mucilage has an amylase of less than 2% and the rice without a mucilage has an amylase of more than 5%.

According to an embodiment herein, the industrially produced rice comprises a starch, a protein, a lipid and an ash, a mineral, a vitamin, fibers and additives and 20% of moisture. The starch is 89% of dry materials. The amount of protein is equal to 8.2246 based on a dry material with a coefficient of 5.95. The mineral is selected from a group consisting of potassium, phosphor, iron, sodium and calcium and combination thereof. The vitamin is selected from a group consisting of vitamin B1 and vitamin B2 and combination thereof. The additives are less than 1% as a whole. The rice has a pH of 6.29. The rice has an acidity of 1.6. The rice particles have a property to withstand a temperature of 33.3° C. and a pressure of 10 bar. The additives include extract of beef, extract of chicken, extract of wheat stem and extract of rice stem. The rice has a taste and a smell similar to a natural rice.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 shows a flow chart illustrating the steps of producing an artificial rice industrially, according to an embodiment herein.

FIG. 2 shows a functional block diagram illustrating the various steps, in general, in the production process of an industrial rice, according to an embodiment herein.

FIG. 3 shows a perspective view of a mixer used to mix the materials in the production process of an industrial rice according to an embodiment herein.

FIG. 4 shows a front view of a blade of polymatic mixer, used in the production process of an industrial rice according to an embodiment herein.

FIG. 5 shows a schematic way of mixing of a paste using the spiral mixer, in the production process of an industrial rice according to an embodiment herein.

FIG. 6 shows a front view of a press mold used for molding in the production process of an industrial rice according to an embodiment herein.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### DETAILED DESCRIPTION OF THE EMBODIMENTS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

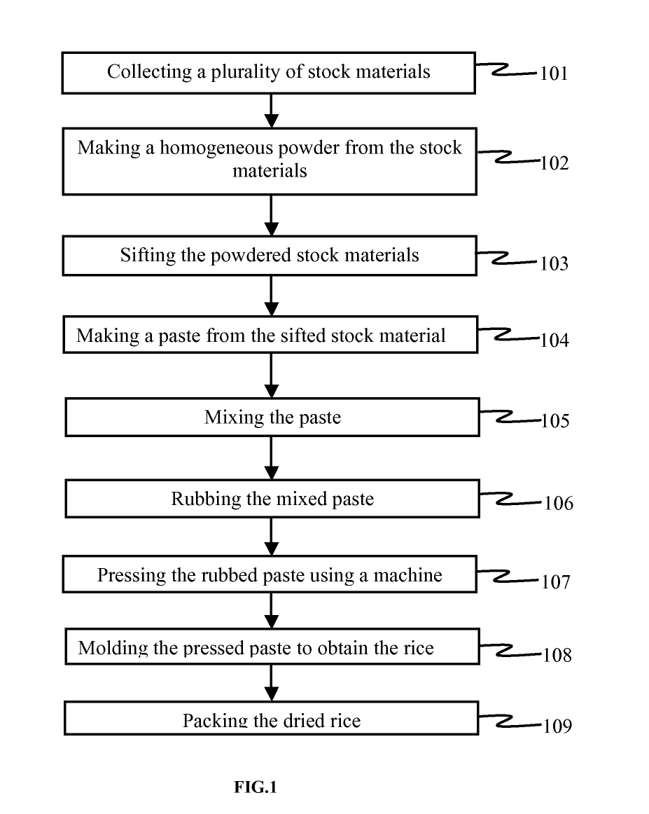

FIG. 1 shows a flowchart illustrating the steps of producing the rice, according to an embodiment herein. With respect to FIG. 1, a plurality of stock materials is collected (101). The plurality of stock materials is selected from a group consisting of starch, grains, vitamins, iron, organic and inorganic materials, paper and wood particles and combination thereof and wherein the starch includes the starch of wheat, corn, barely, potato and wherein the grains include the grains of wheat, barley, chickpea and potato. A homogeneous powder is made from the stock materials (102). The powder is sifted (103). A paste is made (104) from the sifted stock material using a paste maker lacuna by adding water. The water is added up to 20-30% by keeping the temperature at 32-38° C. The paste is mixed (105) using a mixer for 5 minutes at 40° C. Then the paste is rubbed (106) using a pair of roller and then the paste is pressed (107). The paste is pressed using a machine called cromola machine. The cromola machine has at least a pair of roller and a vacuum. The paste is pressed under vacuum. After pressing, the paste is molded to obtain the rice (108). The rice is then dried and packed for storage and consumption (109).

According to the various embodiments herein, the rice is produced using nano technology. All materials used to make the rice are in the form of nano particles and are adhered to each other by the natural chemical bonds. The particles cling together by the process of nano-technology. The molecular bond composition of industrial rice is linear and includes protein and starch.

According to various embodiments herein, the rice can be produced with various properties. Considering various properties of rice grains like weight, length, thinness or roundness, rice is classified into following groups: long-grain rice, medium-grain rice, short-grain rice. In long-grain rice, the length of burnished grains is 7 mm or more, and is called as Sadri in Iran and are classified as Salary grains rice, the black tail Sadri, Normal Sadri, Amiry and Arbaby according to their length and thinness. In medium-grain rice, the length of burnished grain is 6 to 7 mm, and is called Unripe Champa in Iran. The different kinds of medium-grain rice are: The Black Champa, The Formal Champa, The White Champa and The Nameless Rice. It is considerable that Sadri rice grains are weaker than Champa and also they are more sensitive to the pests and water shortage than the Champa. In short-grain rice, the length of burnished grain is about 5 to 6 mm, and is called Champa. The grains having lengths of less than 5 mm are called knot rice in Iran.

Rice is divided into 3 groups according to the weight of its grains. The three groups are named as follows: very heavy rice grains, heavy rice grains and little heavy rice grains. In very heavy rice grains, the weight of 1000 grains is more than 28 gm. Heavy rice grains have weight of 1000 grains between 22 to 28 gm. The little heavy rice grains have weight of 1000 grains less than 22 gm. Rice is divided into two groups according to the amount of starch present with a mucilage and without a mucilage. The starch of rice containing mucilage is in the form of amylopectin and the amount of its amylose is less than 2%. When the amount of amylose is less, the rice becomes stickier. In a rice without mucilage, the available starch in the endosperm of this kind of rice is hard and glassy so the grains do not stick to each other while cooking. The amount of amylose in this kind is more than 5%.

The whole process of production of industrial rice in the embodiments herein, lasts for 30 minutes. The benefit of the process is the reduction and management of time as compared to the natural process. A total of at least 20 tones rice is produced daily. The time needed to produce the product is between 2 to 4 hours per day. The rice is produced with different grain sizes i.e. big, middle and little or globular, as an embodiment herein. The rice with different weights i.e. very heavy rice grains, heavy rice grains or a little heavy rice grains are also produced, according to an embodiment herein. The rice with mucilage, without mucilage and slight mucilage is also produced, according to one embodiment herein. The rice is produced with different colors like the brown rice and white rice, according to an embodiment herein.

According to the embodiments herein, the industrial rice comprises starch, protein, lipid, ash, minerals, fibers and moisture. The other materials present in the industrial rice are potassium, phosphor, iron, sodium, B1 and B2 vitamins, fat and calcium. Table 1 shows the percentage of various material present in the rice, according to an embodiment herein.

TABLE 1
MATERIAL PRESENT IN THE RICE

| Materials | Percentage in brown rice | Percentage in white rice |
|---|---|---|
| Water | 12 | 12 |
| Protein | 5.7 | 6.6 |
| Starch | 76 | 80 |
| Calcium | 32 | 25 |
| Phosphor | 220 | 95 |
| Iron | 1.6 | 0.8 |
| Sodium | 10 | 5 |
| Potassium | 215 | 90 |
| Vitamin B1 | 0.35 | 0.60 |
| Vitamin B2 | 0.50 | 0.30 |

Starch is considered as the main agent in rice composition, and constructs 89% of dry materials of industrial rice. 89% of starch has been refined and generated through any cellulose material. The reaction of rice to a cooking process and the type of starch are highly interactive. The amount of protein, based on dry material with a coefficient of 5.95, is equal to 8.2246. Rice is composed of two types of molecules, namely amylase and amylopectin. The amylase molecule's structure is linear and consists of 50 units of dextrose. However, amylopectin molecules are non-linear and have more dextrose units. Increasing the ratio of amylose molecules to amylopectin molecules leads to more gelatinous, higher temperature and less water absorption. The percentage of moisture is decreased to achieve higher quality and more stable status. The moisture of the rice has to be kept at 20% by weight. The rice has a pH of 6.29, acidity equal to 1.6, temperature of 33.3° C. and pressure inside the particles of 10 bar, according to an embodiment herein.

According to an embodiment herein, different additional materials or additives like colors and tastes are added to the rice according to the desire of the consumer. The additives are added by reducing and increasing the capabilities. The additional materials or additive has to be kept less than 1% as a whole. The additives include extract of beef and chicken and other poultries like duck, emu, goose, etc, and also extract of wheat and rice stem, according to an embodiment herein. No chemicals exist in the rice and all materials are provided naturally. All the materials are provided through nano-technology natural processes.

According to an embodiment herein, the various factors governing the quality of rice include the factors like temperature, moisture, additives, heat, etc. Also the equipment used such as the type of mixer, affects the quality of rice. The approximate temperature has to be kept at 40° C. The amount of moisture has to be less than 15%. The additional materials have to be kept within at least 1% in total. Applying direct heating boiler and mixer are the impressive factors in the work process. The total energy produced by the rice is 360 calories, according to an embodiment herein.

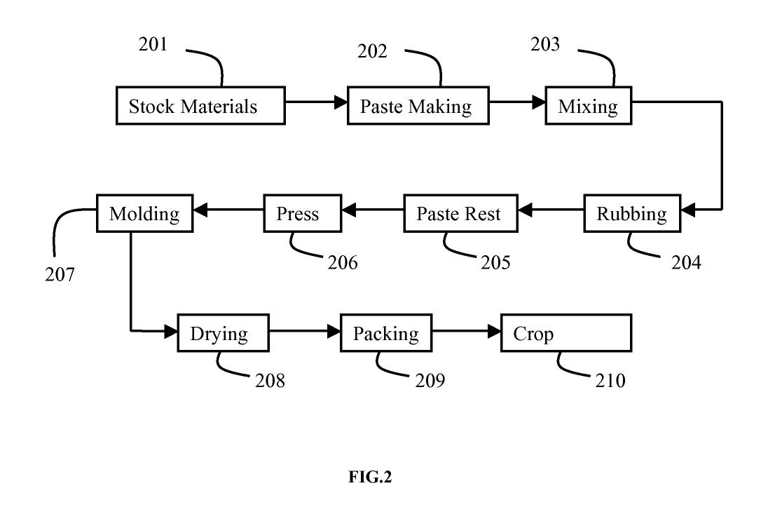

FIG. 2 shows a functional block diagram illustrating the various steps, in general, in the production process of industrial rice, according to an embodiment herein. With respect to FIG. 2, stock materials (201) are collected and made into a homogenous powder. The stock materials herein include different kinds of starch materials like the starch of wheat, corn, barely, potato and the other cereals. The stock materials also include the grains of all cereals such as wheat, barley, chickpea, potato, paper and wood particles. The powdered materials are made into a paste (202) using a paste maker lacuna. The paste is then mixed thoroughly using mixers (203). Special mixers are used for mixing. The mixed paste is then rubbed (204) by rollers. The speed of rubbing is very important. Low speed and long time of rubbing process damage the paste but high speed also has a negative effect on it. To have a paste with desirable quality, physical and thermo dynamical conditions have to kept at equilibrium. The paste is kept still for a while to remove any pressure remaining in the paste (205). The paste is pressed to extract an oxygen from within the paste (206). The paste is then entered into a press mold for molding (207). In this phase, the paste is molded into different sizes and shapes, depending on the variety of molds. The paste is molded in a shape of a rice grain, to make it similar to a natural rice. The rice thus obtained is dried (208). Stable stoves are used to dry the paste. The dried rice is packed (209) and stored (210) for usage and consumption.

According to an embodiment herein, the process of production of industrial rice has three phases and the three phases include mixing, molding and drying processes. The rice produced herein is produced using different kinds of starch materials like the starch of wheat, corn, barely, potato and the other cereals. The edible rice is produced from the grains of all cereals such as wheat, barley, chickpea, potato, etc. with the same taste and quality. The stock material also includes vitamins, iron, organic (mineral) and inorganic materials that are necessary or has been ordered by the consumer. The taste and smell of the rice produced according to the embodiments herein is similar to that of the natural rice. Instead of wheat grains and cereals, the edible rice is also produced with paper and wood particles, according to an embodiment herein. According to an embodiment herein, the stock material comprises a kind of soft starch of corn and the lump starch of wheat grains and a part of barely mallet along with the juice of Omega 3 taste and several useful additives. The materials are very varied and widely available. The stock materials are collected in the stock material tank. Water and liquid additives are kept in a water and juice tank.

The powdery stock materials are sifted to remove the existing lumps and to obtain a powder with uniform temperature. A vibration strainer is used for sifting the materials. The sifted stock materials are put in a paste maker lacuna. The paste maker lacuna is a warm air lacuna. Inside the lacuna, the powdery materials are mixed with 20-30% of water. The temperature of water is kept at 32-38° C. The amount of water suction by different materials is different and depends on the percent of the stock materials. It is possible that the paste is damaged owing to the high temperature. Thus, the lacuna has two walls with cold water flowing in between, in order to protect the paste against the damages due to a high temperature condition.

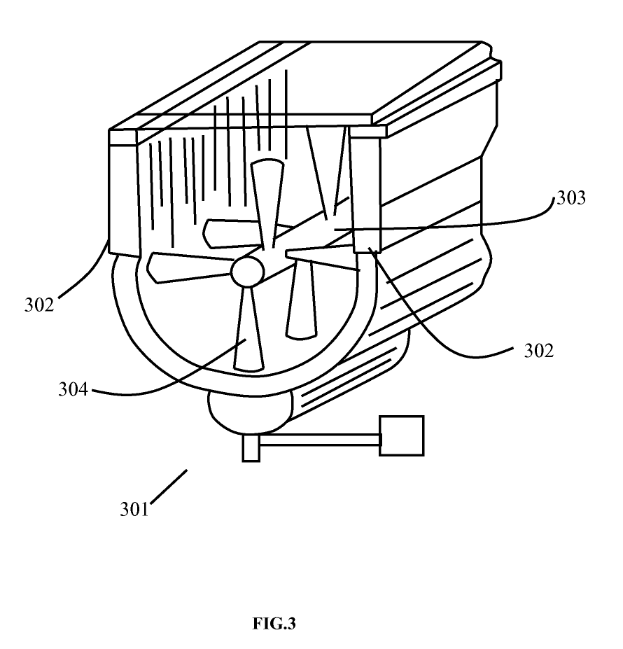

FIG. 3 shows a perspective view of a mixer used to mix the materials, according to an embodiment herein. With respect to FIG. 3, the mixer is in the form of an incomplete cylinder with two walls 302. The mixer is made up of rust-proof steel or metal covered with Teflon. The mixer has an axle 303 with thin blades 304 on it. The blades of mixer has to be thin and move fast to prevent conglomeration. The desired time for mixing is 5 minutes and the temperature is about 40° C. The substances and particles are mixed in isolation and completely in closed condition. It is possible that air may enter the gluten lattice when the paste is mixed. With the assistance of the lipoxide enzyme, the oxygen in the air oxidizes the pigments. Moreover, the existence of air in the gluten lattice causes the air bubbles to increase. The air bubbles cause damage to the quality of crop and its color. The bubbles also have negative effects on the process of drying the paste. The mixer has to be preserved from air entry. For this purpose, a vacuum stream is to be established over surface of the paste during the process of mixing in order to evacuate the air and oxygen from the mixer to prevent their negative effects. The time, style and temperature of mixing, the form of mixer blades and its revolutions have very much significant effect on the quality of the paste. All of these are regulated during the process of production in an optimum form.

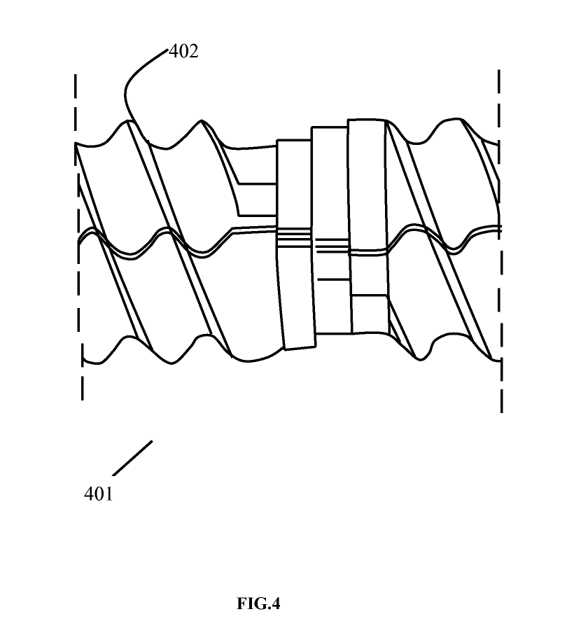

According to an embodiment herein, the mixing is done on the basis of spiral movements. The mixers that work on the principle of spiral movements are called Polymatic mixers. FIG. 4 shows a front view of a blade of polymatic mixer or a spiral mixer, according to an embodiment herein. With respect to FIG. 4, the blade 401 of the polymatic mixer has spiral edges 402. The spiral edges mix the paste from inside and around and whirl the paste from its inside so that the paste is mixed better.

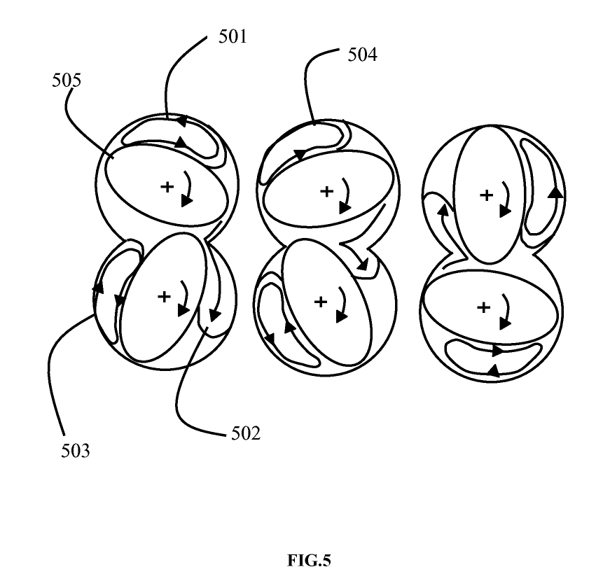

FIG. 5 shows a schematic way of mixing of a paste using the spiral mixer, according to an embodiment herein. With respect to FIG. 5, the paste 501 rolls over the spiral blade 505 and reaches a position 502 then to a position 503. Then the paste again reaches an upward position 504 and the cycle goes on. The spiral blades move the paste in an upside down manner and inside-outside manner for a uniform mixing of the materials or ingredients.

The paste is rubbed by rollers, according to an embodiment herein. The speed of rubbing is very important. Low speed and long time of rubbing damages the paste. The high speed also has negative effects on the paste. To have a paste with a desirable quality, the physical and thermo dynamical conditions have to be kept at equilibrium. The oxygen and available gases in the paste lattice is evicted by rubbing the paste when the paste moves towards the vacuum.

According to an embodiment herein, a Cromola machine is used for pressing. The machine is made up of rollers. The rollers contain rakes that are the supplement to the rubbing machine. The machines have been furnished with the vacuum system. The paste is pressed to extract oxygen from within the paste. The press system is an automatic press system.

The paste is kept still for a while to remove any pressure remaining in the paste, according to an embodiment herein. This is called paste resting.

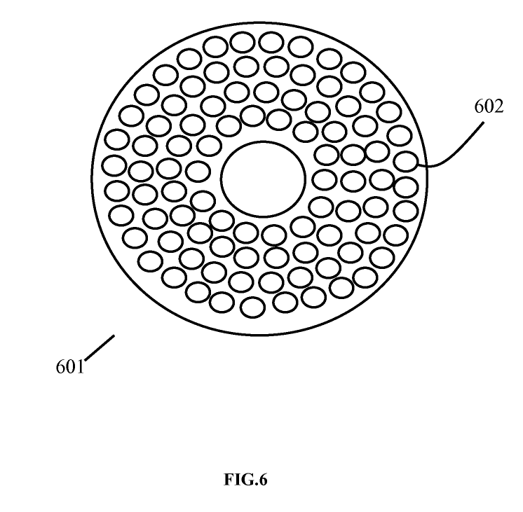

A press mold is used for molding. FIG. 6 shows a front view of a press mold used for molding, according to an embodiment herein. With respect to FIG. 6, a press mold 601 with many holes or voids 602 can be seen. In the press mould, the paste is put under high pressure to form a desirable shape. The paste is molded into different sizes and shapes, depending on the variety of molds. It is important to note that that the kind of mold has much effect on the form and quality of the crop. The mold has to be provided with many holes. The holes do not have negative effect on the pressure applied on the paste. The clearance and erosion of the mold has to be controlled because high pressure application of the process affects the mold and causes erosion and attrition that have undesirable effect on the final crop. The dimensions of the mold is measured and designed by the CNC system.

Drying is the last and the most important phase of the production process, according to the embodiments herein. Drying is done to achieve a balance between the relative moisture and the air of the produced crop at the preservation or storage place or area. Stable stoves are used for drying. The stoves are cubicles where the pastes are carried into by a portage cart or trolley. The stoves are equipped with thermal system and moisture exit. A system of artificial air stream is also used in the stove. To prevent removal of heat from the system, to heighten the profitability and also to prevent temperature variations in the stove that may result in the crack of crop, the problem of isolation is very important.

Continual Tunnel driers are also used for drying, according to an embodiment herein. Theoretically the basis of work in all the driers is similar. The continual tunnel driers have a blower fan of hot air and a moisture suction system. In continual tunnel driers, with the exiting moisture of tunnel, a negative pressure is created so that the replacement of new warm air is needed. For this, a lid furnished with a damper is installed at the top of the tunnel of driers. The lid opens to enter fresh air when the air pressure gets reduced in the lacuna of the drier. The kind of body, the dimensions of drier, the installed windbreaker in the tunnel or stove, speed, temperature and the moisture of air stream, are all the effective parameters to be monitored and controlled in the drying process and for achieving a desired quality of the rice crop.

According to an embodiment herein, the system of producing rice industrially comprises of 15 separate parts. The 15 parts include the machines and equipments required for the production of rice. The 15 separated parts are linked to each other by tunnels, according to an embodiment herein. Table 2 shows the names of the 15 parts.

TABLE 2
PARTS USED IN INDUSTRIAL PRODUCTION OF RICE

Stock material Tank
Water and juice tank
Roller
Mold
Isolation Cubicle
Carrier band
Drier
An automatic Press system
Trommel
A Warm Air Lacuna
Air Blower
Two Wall mixer
A Vibration Strainer
Two Wall Pot
The Packing system

The stock materials are collected in the stock material tank. Water and liquid additives are kept in a water and juice tank. The materials are transferred via a carrier band. The press system is an automatic press system. The paste maker lacuna is a warm air lacuna. A vibration strainer is used for sifting the materials. The system comprises several parts that are continuous, tunnel and a rail part along with the carrier band that is connected to an autoclave linked to a packing system. The mold herein is special and prevents the stock material from sticking, according to an embodiment herein. The system is activated by the process of production and particles' temperature. The several parts of the system are joined to each other wholly and simply and are directed via small robotic system. The stuff or the produced product is packed and completely dried within the mold. The system shortens the process from production to use. The system is fully automatic and dry stuffs change to a crop in less than 10 minutes.

The last stage comprises of the quality control and the accomplishment of necessary tests according to the international standard. Fortunately, the desirable results after 3 years of accurate research and survey on the other crops like wheat, potato, etc were achieved. The results of tests have been verified by the laboratory of industrial research organization of Iran.

After considering the nature of stock materials in the embodiments herein, there is not any pollution created from the wastes of the production process. The system can be established along the central refinery system in any industrial town for benefits. The system has two sewages: human sewage and the sewage generated after washing of equipment, which is done once in a while. The process is almost a dry and there isn't any need for the wash of production equipment every day. It is possible to enter the sewage of this section into the sewage system of the industrial town.

According to the embodiments herein, the produced rice is exactly similar to the natural rice. The natural rice and the industrial rice according to the embodiments herein, have some similarities. Both contain elements like potassium, starch, water, phosphorous, iron, sodium, vitamins B1 and B2, protein oil, calcium, etc. The natural rice and industrial rice have similar alimentary properties. The natural rice and industrial rice have almost same form, taste and color.

The rice is produced from all cereal grains. The rice is produced via nano-technology. The process is a short term planting process using a new technology. The production process is shortened to a day from several months. The production is increased to a several tons per day without causing any harm to environment. The process is economical and less expensive in relation to the time employed, water used, man-power required and the national capital used. Various vitamins can be added according to the consumer's needs. The taste of the rice is varied depending on the taste of the user. The rice is produced in cheaper than that of the natural rice. The rice can be produced in every place and at any time. The process of producing the rice according to the embodiments herein is accomplished with in few hours and the crop is ready to use.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A method of producing rice industrially, comprising the steps of:
collecting a plurality of stock materials;
making a homogeneous powder from the stock materials;
sifting the powdered stock materials;
making a paste from the sifted stock material by adding a water, wherein the paste is made using a paste maker lacuna, wherein an amount of the water is added to make a water percentage of 20-30% and wherein the temperature of water is kept at 32-38° C.;
mixing the paste made from the sifted stock material, wherein the paste is mixed using a mixer, wherein the paste is mixed for 5 minutes at 40° C.;
rubbing the mixed paste, wherein the paste is rubbed using a pair of rollers;
pressing the rubbed paste using a machine, wherein the machine is cromola machine, wherein the machine has at least a pair of rollers and a vacuum;
molding the pressed paste to obtain the rice;
drying the molded rice; and
packing the dried rice.

2. The method according to claim 1, wherein the rice is produced depending on a consumer's requirement, wherein the consumer's requirement includes a taste of the rice, a colour of the rice, a size of the rice and nutrients present in the rice.

3. The method according to claim 1, wherein the plurality of stock materials is selected from a group consisting of starch, grains, vitamins, iron, organic and inorganic materials, paper, wood particles and combination thereof, and wherein the starch includes the starch of wheat, corn, barely, potato and wherein the grains include the grains of wheat, barley, chickpea and potato.

4. The method according to claim 1, wherein the stock material is varied in an amount depending on a consumer's requirement.

5. The method according to claim 1, wherein the rice has particles in a form of nano particles wherein the nano-particles are adhered to each other by a chemical bond.

6. The method according to claim 1, wherein the rice with a plurality of grain size is produced, wherein the plurality of grain size includes a long grain size, a medium grain size, a short grain size and a smaller grain size, wherein the long grain size includes a grain with a size of more than 7 mm, wherein the medium grain size includes a grain with a size of 6 mm to 7 mm, wherein the short grain size includes a grain with a size of 5 mm to 6 mm, and wherein the smaller grain size includes a grain with a size of less than 5 mm.

7. The method according to claim 1, wherein the rice with a plurality of weights is produced, wherein the plurality of weights include very heavy rice grains, heavy rice grains and little heavy rice grains, wherein the very heavy rice grains has a weight of more than 28 gm for 1000 grains, wherein the heavy rice grains has a weight in a range of 22 gm to 28 gm for 1000 grains and wherein the little heavy rice grains has a weight of less than 22 gm for 1000 grains.

8. The method according to claim 1, wherein the rice is produced with a mucilage and without a mucilage, wherein the rice with mucilage has an amylase of less than 2% and wherein the rice without a mucilage has an amylase of more than 5%.

9. The method according to claim 1, wherein the rice produced is in a quantity of at least 20 tonnes per day.

10. The method according to claim 1, wherein the rice is produced in a time period of 30 minutes.

11. The method according to claim 1, wherein the mixer is a two wall mixer.

12. The method according to claim 1, wherein the mixer is a spiral mixer.

13. An industrially produced rice comprising:
a starch, wherein the starch is 89% of dry materials;
a protein, wherein the protein is equal to 8.2246, based on a dry material with a coefficient of 5.95;
a lipid;
an ash;
a mineral, wherein the mineral is selected from a group consisting of potassium, phosphor, iron, sodium, calcium and combination thereof;
a vitamin, wherein the vitamin is selected from a group consisting of vitamin B1, vitamin B2 and combination thereof:
fibres and additives, wherein the additives are less than 1% as a whole.

14. The rice according to claim 13, wherein the rice has a moisture content of 20%.

15. The rice according to claim 13, wherein the rice has a pH of 6.29.

16. The rice according to claim 13, wherein the rice has an acidity of 1.6.

17. The rice according to claim 13, wherein the rice has a temperature of 33.3° C.

18. The rice according to claim 13, wherein the rice withstands a pressure of 10 bar.

19. The rice according to claim 13, wherein the additives include extract of beef, extract of chicken, extract of wheat stem and extract of rice stem.

20. The rice according to claim 13, wherein the rice has a taste and a smell similar to that of a natural rice.
